(19) United States
(12) Patent Application Publication
(10) Pub. No.: US 2003/0112511 A1
(43) Pub. Date: Jun. 19, 2003

(54) Polarization conversion method for liquid crystal displays

(75) Inventor: Peter J. Janssen, Scarborough, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/024,775

(22) Filed: Dec. 19, 2001

(51) Int. Cl. G02B 5/30; G02B 27/28

(52) U.S. Cl. 359/494; 359/495; 359/487

(57) ABSTRACT

A non-polarized input beam has a waist matching that of the light input surface of a polarizing beam splitter wherein the beam is divided into P and S components. The P component exits through a ½ wave retarder and the S component is directed to a turning prism from which it exits in tandem with the P component to form an output beam having a geometrical extent substantially twice that of the input beam. The P and S components are confined by sides of the splitter and the prism, respectively, by Total Internal Reflection, thereby achieving high efficiency without increasing the size of the optical components from that of lower efficiency, prior art polarization converters.

### TECHNICAL FIELD

This invention relates generally to methods of converting non-polarized light into polarized light and, more, particularly, to the polarization conversion methods and are particularly useful in providing polarized input beams to projectors for liquid crystal displays.

### BACKGROUND TECHNOLOGY

Liquid Crystal (LC) light valves modulate light by changing the polarization of light passing through the birefringent LC medium. Currently, non-polarized light is converted to the polarized input light required by LC based projectors by one of a number of systems, typical examples of which are discussed later herein. In LC systems, it is generally desirable to minimize the size of the light valve in order to minimize the cost and/or size of a projector. However, reduction in light valve size results in a concomitant reduction in light output. As a result, with existing polarization conversion techniques, the components must be relatively large and expensive for efficient light collection.

The present invention is directed to overcoming one or more of the problems or disadvantages associated with the relevant technology.

### SUMMARY OF THE INVENTION

In general it would be desirable to improve polarization conversion efficiency and, at the same time, enable the use of relatively small optical components. Accordingly, a method has been developed wherein the input beam is divided into P and S components by a polarizing beam splitter, the dimensions of which are matched to the dimensions of the input beam “waist,” i.e., the minimum cross sectional size of the beam. Light passing through the optics is confined by Total Internal Reflection (TIR). The P component is confined by TIR in the polarizing beam splitter, and the S component is confined in the turning prism. The result is a polarization conversion which increases the geometrical extent by no more than a factor of two, which is the theoretical limit. TIR is achieved by providing air gaps between opposing surfaces of the optical components or by joining the surfaces with low refractive index optical cement.

### BRIEF DESCRIPTION OF THE DRAWINGS

FIGS. 1a and 1b are diagrammatic illustrations of prior art polarization conversion techniques using collimated light;

FIGS. 2a and 2b are diagrammatic illustrations of the limitations of prior art systems;

FIG. 3 is a diagrammatic illustration of the principle of the present invention;

FIGS. 4a, 4b and 4c are side elevational, top plan and rear elevational views, respectively, of the optical elements employed in FIG. 3; and

FIG. 5 is a side elevational view of a modified version of the elements of FIG. 4a.

### BEST MODE FOR CARRYING OUT THE INVENTION

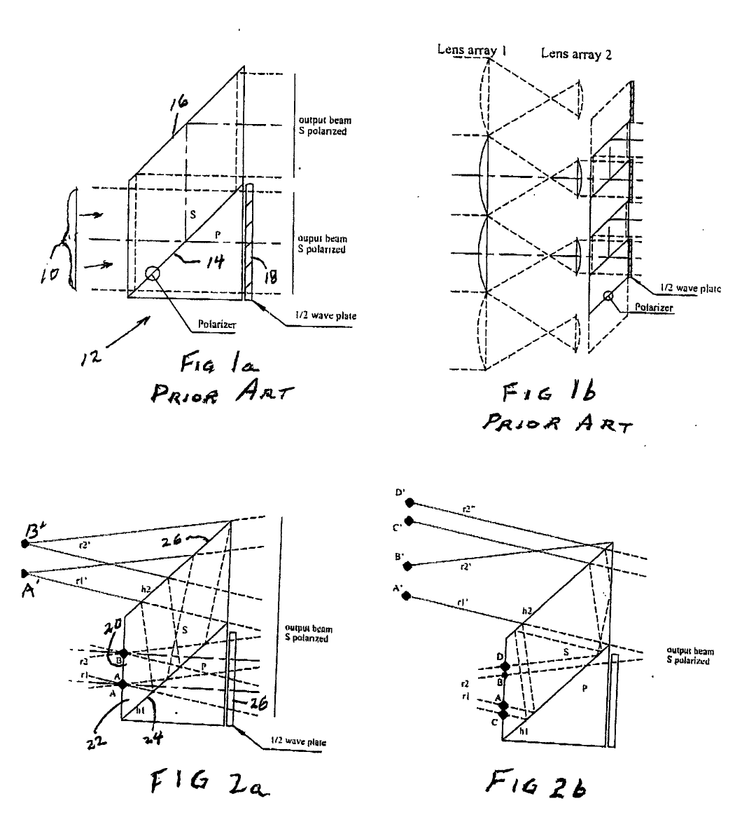

In the conventional polarization conversion technique illustrated in FIG. 1a, a beam 10 of non-polarized light is directed into the polarizing optics 12 from left to right. The beam is divided by 45 o polarizing beam splitter 14 into P and S components. The S component beam is reflected by mirror 16 and the P component beam passes through M wave retarder 18 to place it in phase with the S component, the full output beam then being S polarized. The same effect is achieved using first and second lens arrays in the example of FIG. 1b.

The diagrams of FIGS. 2a and 2b illustrate why conventional polarization conversion systems become inefficient by attempting to minimize optical component dimensions and why the geometrical extent (etendue) of the output beam increases by attempting to improve efficiency. Referring to FIG. 2a, the input beam waist A-B is arbitrarily chosen to coincide with the input face 20 of prism 22. The P component passes through 45 o beam splitter 24 and 1/2 wave retarder 26. The S component is shown being reflected by splitter 24 and mirror 26, creating a virtual image of the waist A-B at A′-B′. Since the virtual image is not coplanar with the waist, the geometrical extent of the beam increases by more than a factor of two. FIG. 2b illustrates the effect of increasing the waist from A-B to C-D. The outer rays through C-D undergo extra reflections, leading to virtual source images C′ and D′, respectively. Thus, the geometrical extent is even further increased from that of the FIG. 2a example.

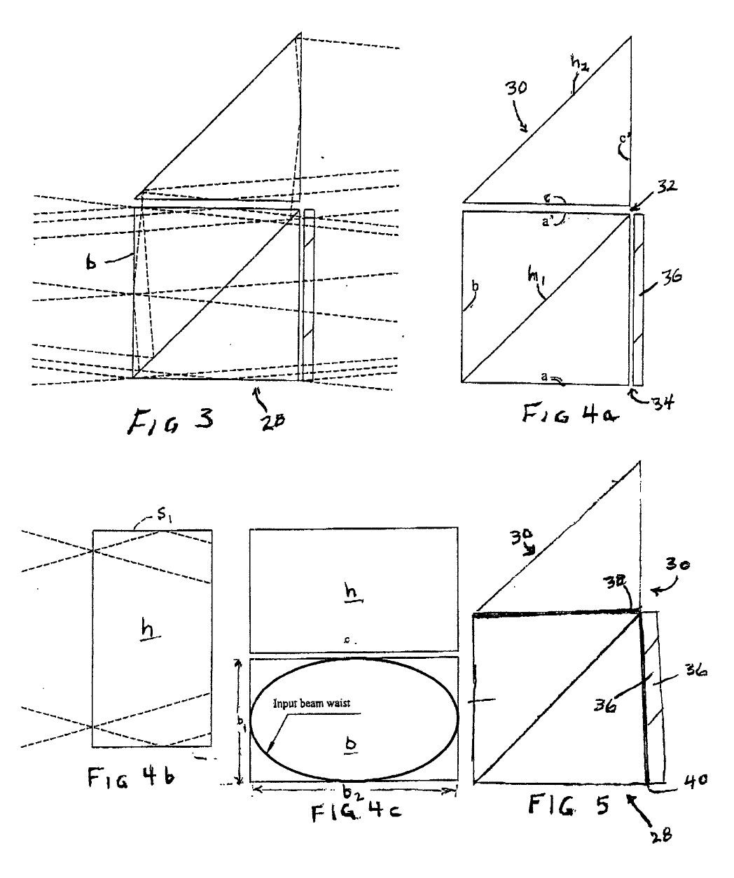

The best mode for carrying out the present invention is through non-imaging polarization conversion with Total Internal Reflection (TIR) employed in the optics, as illustrated in FIGS. 4a-4c and the modified form of FIG. 5 described below.

Functional Description

The input beam aperture is defined by the dimensions of side b of polarizing beam splitter 28. Side b is coplanar with the waist of the input beam which is often elliptical, as shown in FIG. 4c, and the height b1 and with b2 of rectangular side b are chosen to correspond to the minor and major axes, respectively, of the ellipse.

The P component is confined by TIR in the polarizing beam splitter at sides a and a′, whereas the S component is confined in the turning prism 30 by TIR at sides b and c′, and by the sides S1 and S2 of prism 30 (FIG. 4b). The result is a polarization conversion that increases the geometrical extent by a factor of not more than two, which is the theoretical limit. TIR is achieved by providing an air gap at 32 between opposing surfaces of the beam splitter and prism 30, and at 34 between the beam splitter and ½ wave retarder 36, as shown in FIG. 4a.

Alternatively, TIR may be provided by using low refractive index optical cement in layers 38 and 40 between the optical components, as shown in FIG. 5. Thus, polarization conversion efficiency is improved without increasing the size of the optical components.

Other aspects and features of the present invention can be obtained from a study of the drawings, the disclosure, and the appended claims.

1. A method of converting an input beam of non-polarized light having a waist of predetermined height and width in a predetermined plane to an output beam of polarized light having a geometrical extent increased from that of said input beam by no more than a factor of two, said method comprising:
a) positioning a polarizing beam splitter with an input surface having a height and width equal to a predetermined height and width in a predetermined plane, thereby dividing said input beam into perpendicular P and S polarized components;
b) passing said P component light beam through a ½ wave retarder, whereby the light beam exiting said ½ wave retarder has the same polarization as said S component light beam;
c) positioning a turning prism in the path of said S component light beam to direct said S component light beam passed therethrough parallel to and laterally adjacent said P component light beam exiting said ½ wave retarder, said P and S component light beams exiting said ½ wave retarder and said prism jointly forming an output beam having a geometrical extent exceeding that of said input beam by a factor of substantially two; and
d) confining said P and S components by Total Internal Reflection (TIR) in said polarizing beam splitter and said prism, respectively.

2. The method of claim 1 wherein said TIR is achieved by providing a first air gap between parallel, opposing surfaces of said polarizing beam splitter and said prism, and a second air gap between parallel, opposing surfaces of said polarizing beam splitter and said ½ wave retarder.

3. The method of claim 1 wherein said TIR is achieved by providing a first layer of low refractive index optical cement between opposing surfaces of said polarizing beam splitter and said prism, and a second layer of low refractive index optical cement between opposing surfaces of said polarizing beam splitter and said ½ wave retarder.

4. The method of claim 1 wherein said output beam is directed as polarized input light to a liquid crystal based projector.

5. The method of claim 1 wherein said beam waist is elliptical and said input surface is rectangular.

6. The method of claim 1 wherein said turning prism includes parallel side surfaces and said S component light beam is confined in said turning prism by TIR by said side surfaces.

7. A non-imaging polarization conversion method comprising:
a) generating a beam of collimated light having a waist of predetermined height and width in a predetermined plane;
b) positioning a planer, rectangular input surface of a polarizing beam splitter in said predetermined plane, said surface having a height and width equal to a predetermined height and width, a first portion of said input beam passing through said polarizing beam splitter as a P component light beam and a second portion of said beam being reflected by said polarizing beam splitter as an S component light beam;
c) positioning a turning prism in the path of said S component light beam to redirect said S component light beam in a path parallel to and laterally adjacent said P component light beam; and
d) confining said P and S component light beams by Total Internal Reflections (TIR), respectively.

8. The method of claim 7 and further including passing said S component light beam though a ½ wave retarder, thereby placing said S component light beam in phase with said P component light beam.

9. The method of claim 8 wherein said TIR is achieved by providing a first air gap between parallel, opposing surfaces of said polarizing beam splitter and said prism, and a second air gap between parallel, opposing surfaces of said polarizing beam splitter and said ½ wave retarder.

10. The method of claim 8 wherein said TIR is achieved by providing a first layer of low refractive index optical cement between opposing surfaces of said polarizing beam splitter and said prism, and a second layer of low refractive index optical cement between opposing surfaces of said polarizing beam splitter and said ½ wave retarder.

11. The method of claim 8 wherein said waist is elliptical.
